(19) United States
(12) Patent Application Publication
(10) Pub. No.: US 2007/0005606 A1
(43) Pub. Date: Jan. 4, 2007

(54) Approach for requesting web pages from a web server using web-page specific cookie data

(76) Inventors: Shivakumar Ganesan, Bangalore (IN); Bangalore Subbaramaiah Prabhakar, Bangalore (IN); Yarram Sunil Kumar, Bangalore (IN)

Correspondence Address: HICKMAN PALERMO TRUONG & BECKER, LLP, 2055 GATEWAY PLACE, SUITE 550, SAN JOSE, CA, 95110, US

(21) Appl. No.: 11/213,108

(22) Filed: Aug. 25, 2005

(30) Foreign Application Priority Data
Jun. 29, 2005 (IN) 581/KOL/2005

(51) Int. Cl. G06F 17/30

(52) U.S. Cl. 707/10

(57) ABSTRACT

According to the approach described herein, Web page-specific cookie data is used when Web pages are requested from a Web server. When a Web page is requested and received (the parent Web page), Web page-specific cookie data is generated and stored in association with the parent Web page. The Web page-specific cookie data reflects the values, at the time the parent Web page was received, of the cookie data for the Internet domain associated with the parent Web page. When a request is later made for another Web page that the parent Web page refers to, i.e., a child Web page, the Web page-specific cookie data for the parent Web page is retrieved and included with the request for the child Web page, instead of the current cookie data for the Internet domain associated with the parent Web page from a common cookie jar.

### CROSS-REFERENCE TO RELATED APPLICATION

This application is related to and claims the benefit of priority from Indian Patent Application No. 581/KOL/2005 filed in India on Jun. 29, 2005, (Attorney Docket No. 50269-0660) entitled “Approach For Requesting Web Pages From A Web Server Using Web-Page Specific Cookie Data”; the entire content of which is incorporated by this reference for all purposes as if fully disclosed herein.

### FIELD OF THE INVENTION

This invention relates generally to Web crawling, and more specifically, to an approach for requesting Web pages from a Web server using Web page-specific cookie data.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

The most widely used part of the Internet is the World Wide Web, often abbreviated “WWW” or simply referred to as just “the Web”. The Web is an Internet service that organizes information through the use of hypermedia. The HyperText Markup Language (“HTML”) is typically used to specify the content and format of a hypermedia document (e.g., a Web page).

Each Web page can contain embedded references, referred to as “links”, to images, audio, video or other Web pages. The most common type of link used to identify and locate resources on the Internet is the Uniform Resource Locator, or URL. In the context of the Web, a user, using a Web browser, browses for information by selecting links that are embedded in each Web page.

An important aspect of browsing the Web is the use of Internet “cookies”. In general, a cookie is data that is included in the header of a Web page sent by a Web server to a Web browser that is returned by the Web browser to the Web server whenever the Web browser requests Web pages from the Web server. Cookies can contain any arbitrary information a Web server chooses and are used to maintain state between otherwise stateless HTTP transactions. Cookies are typically used to authenticate or identify a registered user of a Web site as part of their first login process or initial site registration without requiring them to sign in again every time they access that site. Other uses include maintaining a “shopping basket” of goods selected for purchase during a session at a site, site personalization (presenting different pages to different users), and tracking a particular user's access to a site.

Because the Web provides access to millions of pages of information that are often poorly organized, it can be difficult for users to locate particular Web pages that contain the information that is of interest to them. To address this problem, a mechanism known as a “search engine” has been developed to index a large number of Web pages and to provide an interface that can be used to search the indexed information by entering certain words or phrases (keywords) to be queried.

Although there are many popular Internet search engines, they generally include a “Web crawler” (also referred to as “crawler”, “spider”, “robot”) that “crawls” across the Internet in a methodical and automated manner to locate Web pages around the world. Upon locating a document, the crawler stores the document and the document's URL, and follows any hyperlinks associated with the document to locate other Web pages. Feature extraction engines then process the crawled and locally stored documents to extract structured information from the documents. In response to a search query, some structured information that satisfies the query (or documents that contain the information that satisfies the query) is usually displayed to the user along with a link pointing to the source of that information. For example, search results typically display a small portion of the page content and have a link pointing to the original page containing that information.

Web crawlers use a wide variety of crawl algorithms to determine the order in which Web pages are crawled. For example, a first-in-first-out by link approach may be used. With this approach, links are crawled based upon the order in which they are located on a Web page. As another example, a “best first” approach may be used where the order in which links are to be crawled is selected based upon link relevancy, i.e., the links considered to be the more relevant are crawled before links that are considered to be less relevant. One of the problems with these approaches is that the crawlers sometimes use cookie data values that do not accurately reflect the correct state for a Web page. This occurs when a crawler crawls Web pages within a related domain in an unexpected order, for example because a relevancy-based selection algorithm is being using, causing the cookie values to be changed.

For example, suppose that a basic Web page domain contains a parent Web page A₁ with links to two child Web pages A₂ and A₃. Child Web pages A₂ and A₃ also contain links to other Web pages. Starting at the parent Web page A₁, the crawler first follows the link to child Web page A₂ and stores the child Web page A₂. The crawler then determines, based upon the particular crawling algorithm being employed, that child Web page A₃ should be crawled before child Web page A₂. This may occur, for example, because the crawler determines, after analysis, that child Web page A₂ has relatively low relevance. Thus, the crawler determines that child Web page A₃ is to be crawled before child Web page A₂. In the process of crawling child Web page A₃, cookie data values for the Web page domain may be changed, for example in response to selections made on child Web page A₃. Also, new cookie values may be established during the crawl of child Web page A₃ that did not previously exist when child Web page A₂ was first retrieved.

Sometime later the crawler determines that child Web page A₂ is to be crawled. The state of child Web page A₂, in terms of its cookies, may now be different and incorrect than when the crawler first received child Web page A₂. When the crawler now crawls child Web page A₂, it will provide to a Web server cookie data values that are different, and in some cases that did not even exist, when the crawler first retrieved child Web page A₂. The result is that the crawler will now receive Web pages that do not reflect the correct state of child Web page A₂.

One possible solution to this problem is to use a Depth First Crawling (DFC) procedure where, starting from a parent Web page of a domain, each unique link path is crawled to the end before another link path is crawled. This approach ensures that the correct cookie values are used when each link path is crawled. This solution has the significant drawback, however, that it prevents the use of crawl algorithms, such as best first, and is therefore undesirable.

Based on the foregoing, there is a need for an approach for requesting Web pages from a Web server that does not suffer from limitations of prior approaches.

### BRIEF DESCRIPTION OF THE DRAWINGS

In the figures of the accompanying drawings like reference numerals refer to similar elements.

FIG. 1 is a block diagram that depicts an arrangement for requesting Web pages from a Web server according to an embodiment of the invention.

FIG. 2 is a block diagram that depicts an example set of Web pages that relate to job listings.

FIG. 3 is a flow diagram that depicts an approach for requesting Web pages, according to an embodiment of the invention.

FIG. 4 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various aspects of the invention are described hereinafter in the following sections:
I. OVERVIEW
II. ARCHITECTURE
III. USING WEB PAGE-SPECIFIC COOKIES TO REQUEST WEB PAGES
IV. OTHER CONSIDERATIONS
V. IMPLEMENTATION MECHANISMS
   I. Overview

An approach is provided for requesting Web pages from a Web server using Web page-specific cookie data. The approach ensures that the correct state, as defined by cookie data values, is used when Web pages are requested, regardless of the order in which Web pages are requested. This allows Web pages to be requested in any order and is therefore well-suited for use with Web crawlers.

II. Architecture

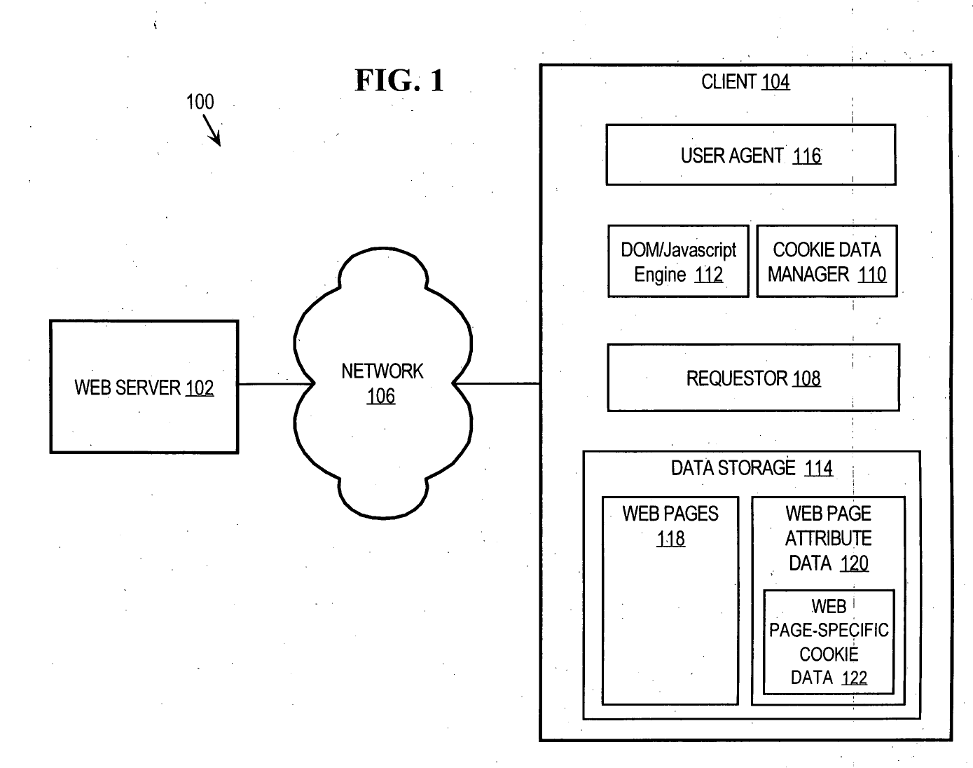

FIG. 1 is a block diagram that depicts an arrangement 100 for requesting Web pages from a Web server according to an embodiment of the invention. Arrangement 100 includes a Web server 102 communicatively coupled to a client 104 via a network 106. Network 106 may be implemented by any medium or mechanism that provides for the exchange of data between Web server 102 and client 104. Examples of network 106 include, without limitation, one or more Local Area Networks (LANs), Wide Area Networks (WANs), Ethernets or the Internet, or one or more terrestrial, satellite or wireless links. Web server 102 and client 104 are depicted in FIG. 1 as being disposed external to network 106 for purposes of explanation only and Web server 102 and client 104 may also be disposed within network 106, depending upon a particular implementation.

Web server 102 may be implemented by any mechanism or process that is configured to process requests for Web pages and provide Web pages in response to processing those requests. Web server 102 may include a wide variety of components and processes that are not depicted in FIG. 1 and described herein for purposes of explanation and the approach described herein for requesting Web pages from a Web server is not limited to any particular type of Web server or Web server configuration. For example, Web server 102 may include a non-volatile storage, such as one or more disks, and a process for processing requests for Web pages and causing Web pages to be generated and provided to the requestor. One example implementation of Web server 102 is an Apache Web server.

Client 104 may be implemented by any mechanism or process configured to request Web pages from Web server 102. One example implementation of client 104 is a Web crawler, although the approach described herein is not limited to this context. According to one embodiment of the invention, client 104 is configured with a requestor 108, a cookie data manager 110, a Document Object Module (DOM)/Javascript engine 112 and a data storage 114. Client 104 may be configured with additional elements and processes and also the elements and functionality of client 104 depicted in FIG. 1 and described herein are not all required. Thus, the particular elements and functionality of client 104 may vary, depending upon a particular implementation.

Requestor 108 is a mechanism or process configured to generate requests for Web pages. Requestor 108 may receive input from a user of client 104. Cookie data manager 110 manages cookie data as described in more detail hereinafter. DOM/Javascript engine 112 may be any type of module or process configured to understand and parse DOM and included Javascript. Any request that involves DOM functionalities and Javascript executed may be routed through the DOM/Javascript engine 112. DOM/Javascript engine 112 is configured with a user agent 116.

Data storage 114 may be implemented by any type of storage, volatile, non-volatile or any combination of volatile and non-volatile storage. Examples of data storage include, without limitation, Random Access Memory (RAM), optical storage, magneto-optical storage, tape and one or more disks. Data storage 114 stores Web pages 118, Web page attribute data 120 and Web page-specific cookie data 122, as described in more detail hereinafter.

III. Using Web Page-Specific Cookies to Request Web Pages

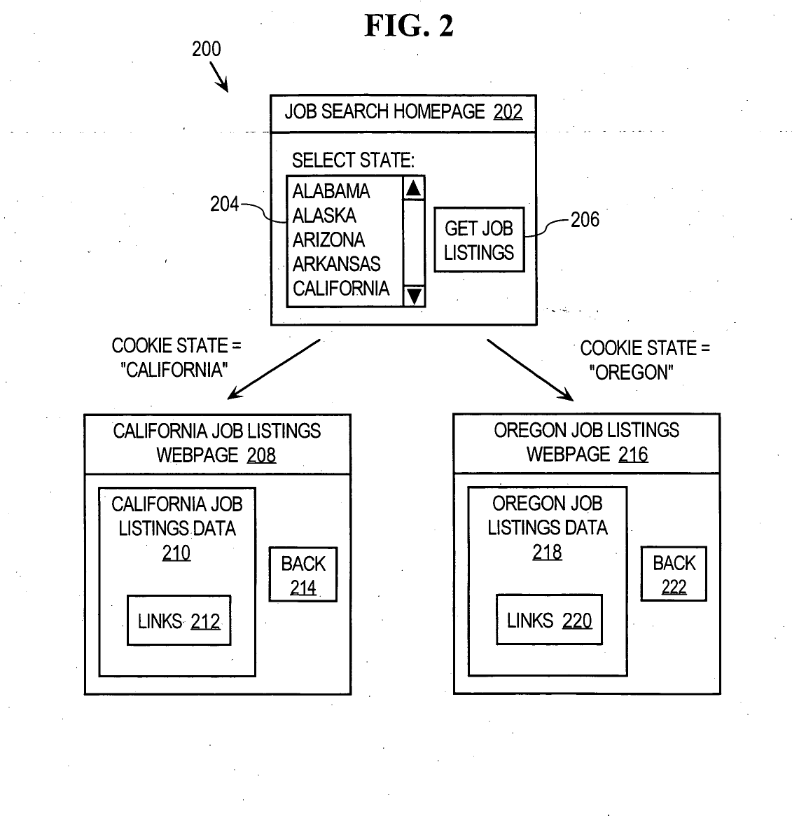

FIG. 2 is a block diagram that depicts an example set of Web pages 200 that relate to job listings. Web pages 200 include a job search homepage 202 that includes a state selector 204, in the form of a scroll box, and a navigation button 206 for obtaining job listing data for the particular state selected via state selector 204. Web pages 200 also include a California job listings Webpage 208 that includes California job listings data 210 with links 212 and a “back” navigation button 214. Web pages 200 also include an Oregon job listings Webpage 216 that includes Oregon job listings data 218 with links 220 and a “back” navigation button 222.

In accordance with dynamic content crawling, a crawler generates a request for a Web page that specifies the URL of job search homepage 202. A Web server processes the request and provides job search homepage 202. The crawler, with the help of a DOM/Javascript engine, selects a state from state selector 204 and clicks the “get job listings” navigation button 206. The DOM/Javascript engine in the crawler generates and sends a request to the Web server. Assuming that California was selected as the state, the request includes the URL of the California job listings Webpage 208. The Web server generates and provides the California job listings Webpage 208 to the crawler, along with cookie data that indicates California. The crawler stores the cookie data in the cookie data file associated with the domain of Web pages 200.

Suppose that the crawler crawls the page based upon a FIFO technique, the crawler then selects the next state in the list, e.g., Oregon using state selector 204 and then clicks the “get job listings” navigation button 206 with the help of the DOM/Javascript engine. The generated request is sent to the Web server that includes the URL of the Oregon job listings Webpage 216. The Web server generates and provides the Oregon job listings Webpage 216 to the crawler, along with cookie data that indicates Oregon. The crawler stores the cookie data in the cookie data file associated with the domain of Web pages 200. At this point in time, the cookie data associated with the domain of Web pages 200 reflects the state of Oregon.

Sometime later, the crawler determines that the California job listings Webpage 208 is to be crawled. The crawler retrieves and analyzes the California job listings Webpage 208 and determines the California job listings Webpage 208 includes links 212 to be crawled. The crawler selects a particular link from links 212 and sends a request to the Web server. The request includes the URL associated with the particular link, post/get data if any, and also the current cookie data values for the domain of Web pages 200. Since the current cookie data values for the domain of Web pages 200 were last set by the crawl of the Oregon job listings Webpage 216, the cookie data values do not correctly reflect the cookie state of California and the crawler will not receive the correct Web pages when crawling links 212. The crawling of the Oregon job listings Webpage 216 may have overridden cookie data values provided by the Web server when the California job listings Webpage 208 was provided to the crawler. Also, the crawling or even the fetch of the Oregon job listings Webpage 216 may have caused new cookie data values to be established.

According to the approach described herein, Web page-specific cookie data is used when Web pages are requested from a Web server. According to this approach, when a Web page is requested and received (the parent Web page), Web page-specific cookie data is generated and stored in association with the parent Web page. The Web page-specific cookie data reflects the values, at the time the parent Web page was received, of the cookie data for the Internet domain present in the common cookie jar. When a request is later made for another Web page that the parent Web page refers to, i.e., a child Web page, the Web page-specific cookie data for the parent Web page is retrieved and included with the request for the child Web page, instead of the current cookie data for the Internet domain associated with the parent Web page. Thus, when the child Web page is requested, the cookie data values are restored to the values at the time the parent Web page was received, regardless of any other interim changes that may have been made to the cookie data for the Internet domain attributable to requests for other Web pages in the same Internet domain.

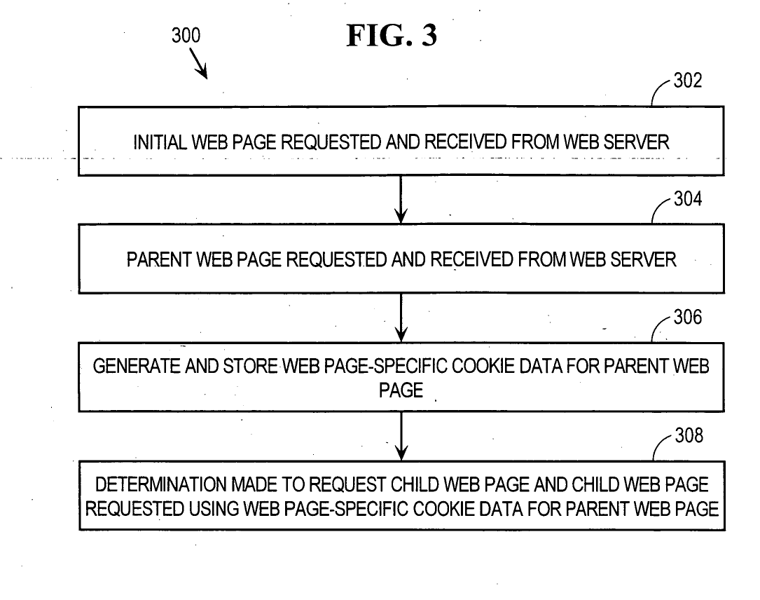

Consider the following example explained with reference to FIG. 2 and a flow diagram 300 of FIG. 3. In step 302, an initial Web page is requested and received from a Web server and stored. In the current example, requester 108 provides the URL of job search homepage 202 to user agent 116. User agent 116 generates an HTTP request and causes the request to be sent to Web server 102. Web server 102 generates and provides job search homepage 202 back to client 104, which causes the job search homepage 202 to be stored in Web pages 118. Web page attribute data, for example, last downloaded time, HTTP header data, document size, etc., may be generated and stored for this Web page in Web page attribute data 120.

In step 304, a parent Web page is requested and received from a Web server. In the current example, requestor 108 provides the URL of California job listings Webpage 208 to user agent 116. User agent 116 generates an HTTP request and causes the request to be sent to Web server 102. Web server 102 generates and provides California job listings Webpage 208 back to client 104, which causes the California job listings Webpage 208 to be stored in Web pages 118. Web page attribute data may be generated and stored for this Web page in Web page attribute data 120.

In step 306, Web page-specific cookie data is generated and stored for the parent Web page. In the present example, cookie data specific to the California job listings Webpage 208 is generated and stored in Web page-specific cookie data 122. This cookie data may reflect the values of any cookie data for the Internet domain to which the California job listings Webpage 208 belongs at the time the California job listings Webpage 208 was received. This may include, for example, cookie data provided by Web server 102 with the California job listings Webpage 208. This may also include, for example, cookie data provided by Web server 102 with the job search homepage 202. Note that in FIG. 3, Web page-specific cookie data 122 is depicted as being stored as part of Web page attribute data 120, but this is not a requirement. Web page-specific cookie data 122 may be stored in Web pages 118, for example in the headers, or in a queriable database with the URL as the key. Web page-specific cookie data 122 may also be stored in other locations, even external to client 104, depending upon a particular implementation.

In step 308, a determination is made to request a child Web page and the child Web page is requested using the Web page-specific cookie data for the parent Web page. In the present example, requestor 108 determines that a particular child Web page associated with a particular link from links 212 is to be requested. The determination of the particular link may be made using any of a wide variety of link selection algorithms, depending upon a particular implementation. Requestor 108 provides the URL of the particular link to user agent 116, which generates and HTTP request and causes the request to be sent to Web server 102. User agent 116 also retrieves the Web page-specific cookie data 122 from data 114 for the parent Web page, which in the present example is the California job listings Webpage 208. This cookie data is sent to Web server 102 with the request for the particular child Web page, instead of the current cookie data values for the Internet domain associated with the parent Web page, the California job listings Webpage 208. This ensures that the cookie values accurately reflect the state of the California job listings Webpage 208 at the time it was received, irrespective of how many other Web pages may have been requested in between the time the California job listings Webpage 208 was received and the child Webpage is requested. Although flow diagram 300 depicts a particular set of steps in a particular order, other implementations may use fewer or more steps, in the same or different order, than those depicted in FIG. 3.

IV. Other Considerations

It is not uncommon for cookie data provided with Web pages to have expiration dates, after which the cookie data is considered invalid. According to one embodiment of the invention, received cookie data is examined to determine whether it include an expiration time. If so, then an additional constraint is provided to crawl any child Web pages prior to the expiration time. Expiration time may be included in Web page attribute data 120 and periodically queried to determine if there are any upcoming expiration times. Thus, expiration time may be included as an input into the algorithm for selecting which Web pages should be selected for crawling.

There may be situations where cookie data values within a set of related Web pages within an Internet domain are relatively static and do not often change. In situations where a parent Web page references a large number of child Web pages, the unchanged cookie data is propagated to each of the child Web pages and stored, resulting in storage of many duplicate values. In these situations, various techniques may be employed to more efficiently store the duplicate data. For example, indexed data structures such as binary trees may be used to store cookie data. Many such data management techniques are available, depending upon a particular implementation, and the approach is not limited to any particular technique.

V. Implementation Mechanisms

The approach for requesting Web pages as described herein greatly improves on prior approaches by provide more accurate crawling of Web documents in any order, thus allowing a crawler to implement a best selection algorithm without regard for the effect on cookies. The approach may be implemented in hardware, software, or any combination of hardware or software, depending upon a particular implementation.

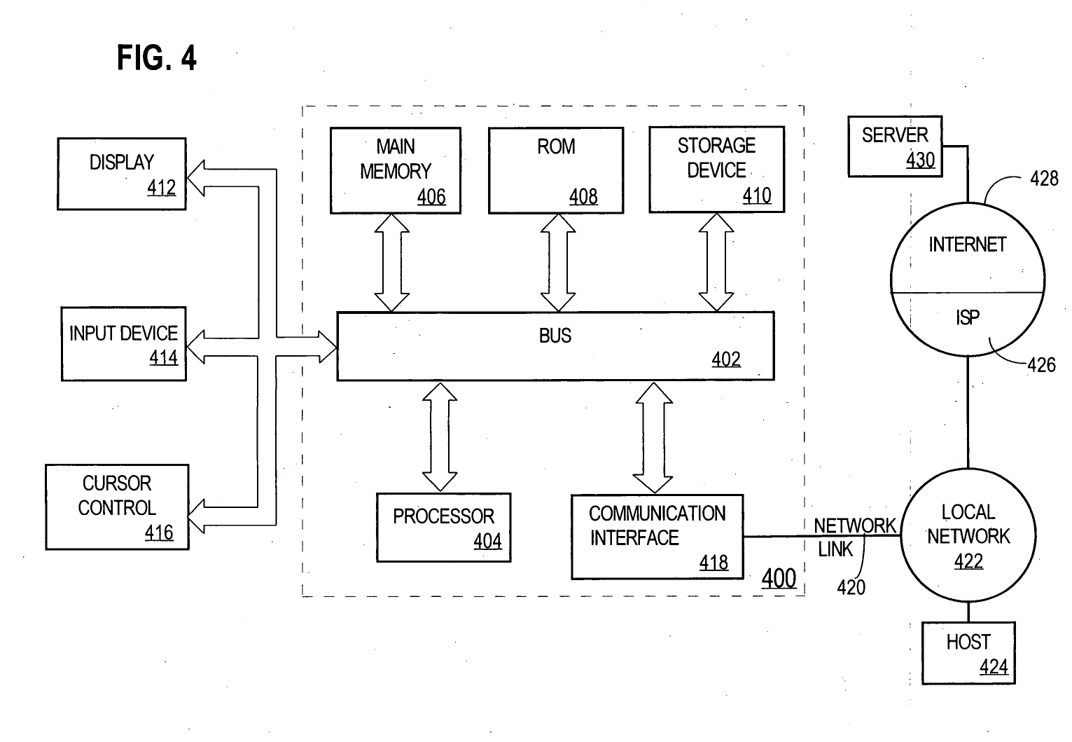

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for requesting Web pages, the computer-implemented method comprising:
requesting a first Web page from a Web server;
receiving the requested first Web page and first cookie data from the Web server;
generating second cookie data and storing the second cookie data in association with the first Web page, wherein the second cookie data reflects the values, at the time the requested Web page was received, of the first cookie data received from the Web server and the values of other cookie data for the Internet domain associated with the first Web page; and
when requesting, from the Web server, a second Web page referenced by the first Web page, retrieving the second cookie data stored in association with the first Web page and including the second cookie data with the request for the second Web page, instead of current cookie data for the Internet domain associated with the first Web page.

2. The computer-implemented method as recited in claim 1, wherein storing the second cookie data in association with the first Web page includes storing the second cookie data in the first Web page.

3. The computer-implemented method as recited in claim 1, wherein:
storing the second cookie data in association with the first Web page includes storing the second cookie data in a data structure, and
the computer-implemented method further comprises generating an index entry that corresponds to the first Web page and references the second cookie state data stored in the data structure.

4. The computer-implemented method as recited in claim 1, wherein a key for the index entry is the URL of the first Web page.

5. The computer-implemented method as recited in claim 1, further comprising determining that the second Web page is to be requested at least in part based upon an expiration time associated with the first cookie data received from the Web server with the first Web page.

6. The computer-implemented method as recited in claim 1, further comprising identifying duplicate cookie data using data structure techniques to reduce the amount of duplicate data.

7. A computer-readable medium for requesting Web pages, the computer-readable medium carrying instructions which, when processed by one or more processors, cause:
requesting a first Web page from a Web server;
receiving the requested first Web page and first cookie data from the Web server;
generating second cookie data and storing the second cookie data in association with the first Web page, wherein the second cookie data reflects the values, at the time the requested Web page was received, of the first cookie data received from the Web server and the values of other cookie data for the Internet domain associated with the first Web page; and
when requesting, from the Web server, a second Web page referenced by the first Web page, retrieving the second cookie data stored in association with the first Web page and including the second cookie data with the request for the second Web page, instead of current cookie data for the Internet domain associated with the first Web page.

8. The computer-readable medium as recited in claim 7, wherein storing the second cookie data in association with the first Web page includes storing the second cookie data in the first Web page.

9. The computer-readable medium as recited in claim 7, wherein:
storing the second cookie data in association with the first Web page includes storing the second cookie data in a data structure, and
the computer-readable medium further comprises additional instructions which, when processed by the one or more processors, cause generating an index entry that corresponds to the first Web page and references the second cookie state data stored in the data structure.

10. The computer-readable medium as recited in claim 7, wherein a key for the index entry is the URL of the first Web page.

11. The computer-readable medium as recited in claim 7, further comprising additional instructions which, when processed by the one or more processors, cause determining that the second Web page is to be requested at least in part based upon an expiration time associated with the first cookie data received from the Web server with the first Web page.

12. The computer-readable medium as recited in claim 7, further comprising additional instructions which, when processed by the one or more processors, cause identifying duplicate cookie data using data structure techniques to reduce the amount of duplicate data.

13. An apparatus for requesting Web pages, the apparatus being configured to:
request a first Web page from a Web server;
receive the requested first Web page and first cookie data from the Web server;
generate second cookie data and storing the second cookie data in association with the first Web page, wherein the second cookie data reflects the values, at the time the requested Web page was received, of the first cookie data received from the Web server and the values of other cookie data for the Internet domain associated with the first Web page; and
when requesting, from the Web server, a second Web page referenced by the first Web page, retrieving the second cookie data stored in association with the first Web page and including the second cookie data with the request for the second Web page, instead of current cookie data for the Internet domain associated with the first Web page.

14. The apparatus as recited in claim 13, wherein storing the second cookie data in association with the first Web page includes storing the second cookie data in the first Web page.

15. The apparatus as recited in claim 13, wherein:
storing the second cookie data in association with the first Web page includes storing the second cookie data in a data structure, and
the apparatus is further configured to generate an index entry that corresponds to the first Web page and references the second cookie state data stored in the data structure.

16. The apparatus as recited in claim 13, wherein a key for the index entry is the URL of the first Web page.

17. The apparatus as recited in claim 13, wherein the apparatus is further configured to determine that the second Web page is to be requested at least in part based upon an expiration time associated with the first cookie data received from the Web server with the first Web page.

18. The apparatus as recited in claim 13, wherein the apparatus is further configured to identify duplicate cookie data using data structure techniques to reduce the amount of duplicate data.
